(19) United States
(12) Patent Application Publication
(10) Pub. No.: US 2012/0322497 A1
(43) Pub. Date: Dec. 20, 2012

(54) CLIENT SIDE CELLULAR HANDOFF PREDICTION

(75) Inventors: Vishnu Navda, Bangalore (IN); Ramachandran Ramjee, Bangalore (IN); Venkata N. Padmanabhan, Bangalore (IN); Anand Padmanabha Iyer, Trivandrum (IN)

(73) Assignee: Microsoft Corporation, Redmond, WA (US)

(21) Appl. No.: 13/160,622

(22) Filed: Jun. 15, 2011

(51) Int. Cl. H04W 36/00; H04B 7/26

(52) U.S. Cl. 455/525

(57) ABSTRACT

One or more techniques and/or systems are disclosed for predicting when a signal handoff may occur from a current base station to a neighboring base station for a mobile device. An indication of signal strength between the mobile device and the current base station and an indication of signal strength between the mobile device and a (e.g., closest) neighboring base station can be monitored by the mobile device. A difference between these signal strength indications can be determined and compared against a threshold (e.g., based upon historical signal handoffs) to predict when and/or where a signal handoff may occur. The predicted signal handoff may be determined by the mobile device and a corresponding notification can be provided so that appropriate action may be taken (e.g., a user may not initiate a call and/or an application may not attempt to communicate data).

### BACKGROUND

On a cellular network, a signal between a mobile device and a base station can connect the mobile device to a network providing communication. When a mobile device user travels with the mobile device across a cell boundary between two neighboring cells, the signal can be handed from the base station, currently connected to the mobile device, to a neighboring base station. In this way, for example, the mobile device user can be provided communication services by the network, while traveling wherever the network has a corresponding base station. Mobile devices are typically used for voice and/or data transmission services with the network, such as to download/upload data, receive notifications, and/or for voice communications. When the signal is handed off, the data communication can be disrupted by the handoff procedure.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Handoffs in cellular data networks are often disruptive. For example, buffering of packets in the network at a time of the handoff can result in a delay spike for receiving/sending data. Furthermore, signal handoffs between base stations attached to different radio network controllers may often be “hard”, resulting in packet loss. The delay spike and packet loss can degrade performance of networked applications running on mobile devices, and/or voice communications, and provide a reduced user experience.

As an example, a 3rd Generation (3G) cellular network may be based on wideband CDMA (WCDMA) that supports “soft” handoffs, which is a make-before-break mechanism that may be able to mitigate a disruption during handoffs. However, soft handoffs utilize additional resource overhead, comprising duplicate, concurrent transmissions by multiple base stations. Therefore, the use of this mechanism is typically confined to performance-sensitive voice traffic, and does not usually extend to data traffic for mobile connections, due to the additional resource overhead.

Accordingly, one or more techniques and/or systems are disclosed for predicting when and/or where a signal handoff may occur for a mobile device. The predicted signal handoff may be used to identify a period for “freezing” data communication that encompasses an actual signal handoff. In this way, for example, data packet loss and/or delay spikes may be mitigated by utilizing a controlled “pause” in the data transmission, which can last until after the signal handoff, at which time normal data transmission may resume. Further, the predicted signal handoffs may be utilized to identify an area where one or more signal handoffs are likely to occur, for example. This information may be compared against actual signal handoffs to further refine the signal handoff prediction, and be integrated with a mapping service to help a user of the mobile device plan accordingly. It may be appreciated that “signal handoff” and/or the like as used herein may be thought of, at least in some instances, as merely a handoff where service provided to a mobile (e.g., cellular) device is transferred or switched from a current base station to a different base station. Thus, in a “signal handoff” and/or the like as used herein, one or more signals to and/or from a mobile device are handed-off from a base station currently servicing the device to a different base station that subsequently services the device. That is, service provided to the mobile device (e.g., in the form of one or more signals to and/or from the mobile device) is handed off from one base station to another. Accordingly, it may not be inappropriate to regard a “signal handoff” as merely a handoff, at least in some instances, as provided herein.

In one embodiment of predicting when a signal handoff may occur between base stations for a mobile device, a first indication of signal strength, such as signal-to-noise ratio (SNR), between the mobile device and a current base station can be received. Further, a second indication of signal strength between the mobile device and a neighboring base station can be received. The first and second indications can be compared to determine a signal difference, and the signal difference can be used to identify a predicted signal handoff, such as based on historical signal handoffs for the network using the base stations, for example. It may be appreciated that SNR may be said to be comprised within an ECNO parameter by those skilled in the art.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary embodiment for predicting when a signal handoff may occur between base stations for a mobile device.

FIG. 2 is a flow diagram illustrating an example embodiment where one or more portions of one or more techniques described herein may be implemented.

FIG. 3 is a flow diagram illustrating an example embodiment of one or more portions of one or more techniques described herein.

FIG. 4 is a graph diagram illustrating an example embodiment of a signal handoff.

FIG. 5 is a component diagram illustrating an exemplary system for predicting when a signal handoff may occur between base stations for a mobile device.

FIG. 6 is a component diagram illustrating an example embodiment where one or more systems described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Mobile devices can be served by base stations (e.g., cell towers) distributed in a way that provides desirable coverage of an area, for a network providing the mobile device with a communication service. Typically, a base station provides connection services to/from the mobile device in a coverage area for the base station, comprising a cell. When a mobile device user moves from cell to cell while their mobile device is connected to the network (e.g., during a telephone call while driving), a signal between the mobile device and a current base station providing the connection is handed off to a neighboring base station, which services the cell into which the user has just moved. During such a signal handoff, the network connection may be compromised in a way that diminishes the users experience, such as losing portions of a conversation, and/or losing portions of data being sent/received by the mobile device. The loss of data can necessitate resending the data, thereby resulting in a delay spike, for example.

Accordingly, as provided herein, a method may be devised that provides for predicting signal handoffs by a mobile device substantially independent of cooperation of a network providing service to the mobile device. An impending signal handoff can be anticipated at a fine time granularity (e.g., a few seconds) based on signal data for example, identified at the mobile device. Further, an estimated frequency of handoffs over longer periods (e.g., a 30-minute drive along a particular route) may be identified, for example, based on historical signal handoff data. In this way, potential negative effects of the signal handoffs may be mitigated, such as data loss, for example, as actions may be taken in anticipation of a predicted signal handoff. Additionally, data throughput for an individual connection may be improved, a cell's aggregate data throughput may be improved, and/or voice connections can be provided with advance notifications for potential connection problems, for example.

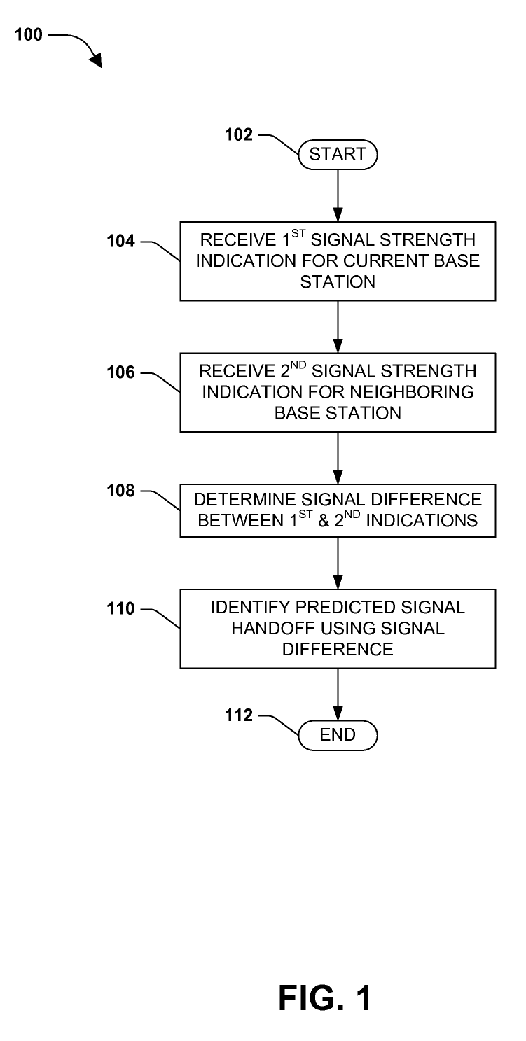

FIG. 1 is a flow diagram illustrating an exemplary embodiment 100 for predicting when a signal handoff may occur between base stations for a mobile device. The exemplary embodiment 100 begins at 102 and involves receiving a first indication of signal strength between the mobile device and a current base station, at 104. For example, the mobile device can detect a signal strength from the base station, which is used to connect the mobile device with a network providing mobile communication (e.g., voice and/or data) for the mobile device.

As an illustrative example, mobile devices can comprise a Universal Mobile Telecommunications System (UMTS) based radio (e.g., High Speed Packet Access (HSPA) base radio) that transmits/receives signals to/from a base station. The mobile device radio can also detect characteristics of the signal (e.g., pilot signal from the base station), such as signal strength, signal-to-noise ratio, and others, for example, which may be periodically sent from the mobile device to the network, for example, as part of normal network operations. In one embodiment, for example, the mobile device may receive a pilot signal from a base station, which can be measured by the receiver (e.g., the radio) and expressed as received signal code power (RSCP) (e.g., signal strength). In another embodiment, the pilot signal can be measured by the receiver and expressed as a signal-to-noise ratio (SNR) or ECNO parameter, for example. As an example, a report of the RSCP and/or SNR for the base station may be periodically sent to the network, such as to monitor network signal characteristics, and/or determine a potential handoff.

At 106, a second indication of signal strength between the mobile device and a neighboring base station is received. For example, in a cellular network environment, base stations can be located so that the user of the mobile device maintains a connection with the network as they move from cell to cell. That is, the user may be located in a current cell that is serviced by the current base station, and the current cell may be surrounded by a plurality of neighboring cells serviced by neighboring base stations, for example. In this example, when the user moves into one of the neighboring cells, their mobile device to network connection can be serviced by the corresponding neighboring base station.

As described above, for example, the mobile device radio may be able to detect a signal (e.g., pilot signal) from one or more of the neighboring base stations. In one embodiment, the mobile device can receive a signal strength indication (e.g., RSCP) of one of the neighboring base stations, for example, which may be stored locally on the mobile device and/or periodically sent from the mobile device to the network as part of normal network operations. Typically, the network with which the mobile device is connected determines when to handoff the connection signal from the current base station to a neighboring base station. For example, when the mobile device moves from a current cell to a neighboring cell the signal strength may indicate to the network that the mobile device is moving into the neighboring cell (e.g., current strength is lessening, neighboring strength is increasing). The network can make a determination to handoff (e.g., migrate, transfer) the signal to the neighboring base station from the current base station based, at least in part, on network signal strength criteria. In this way, a connection can be maintained with the network while the mobile device is moving (e.g., as the user moves). Nevertheless, because data may be maintained locally on the mobile device, a predicted signal handoff can be identified locally by the mobile device with little to no assistance from base stations and/or service providing networks.

At 108 in the exemplary embodiment 100, a signal difference between the first indication and the second indication is determined. For example, a difference can be determined between the base station's RSCP and RSCPs for the respective neighboring base stations. As another example, a difference can be determined between the base station's SNR and SNRs for the respective neighboring base stations. It will be appreciated that the indication of signal strength is not limited to the example embodiments described herein, and it is anticipated that those skilled in the art may devise alternate indications of signal strength. For example, signal strength can denote a magnitude of an electric field at selected point, expressed as signal power (e.g., dBm) or voltage per length (mV/m). As another example, some combination of signal attributes may be applied to identify a signal strength, such as with the SNR, or some other combination.

At 110, the signal difference is used to identify the predicted signal handoff from the current base station to a neighboring base station. In one embodiment, the signal difference between the current and one or more of the neighboring base stations can be a good indicator, amongst other indicators, of a potential, impending signal handoff. For example, as the signal difference increases (e.g., the neighboring base station signal strength increases while the current base station signal strength decreases), a likelihood of signal handoff can also increase. In one embodiment, when the signal difference between the current base station and a neighboring base station meets a desired threshold, which is representative of a probable signal handoff, the predicted signal handoff may be indicated.

In one embodiment, determining the desired threshold that is representative of a probable signal handoff can comprise identifying historical indications of signal differences that are representative of signal handoffs. Empirical data representing signal handoffs may be collected, for example, that are indicative of signal differences recorded when a signal handoff occurred. In this embodiment, for example, identifying the predicted signal handoff can comprise comparing the signal difference to a set of historical indications of signal differences comprising one or more representations of signal handoffs.

In another embodiment, merely the first indication may be compared to a set of historical first indications, representing one or more signal handoffs, to identify the predicted signal handoff. For example, empirical data may be collected that is indicative of signal strengths of the current base station when a signal handoff occurs. As an illustrative example, the signal strength (e.g., SNR) of the current base station can be recorded at a time when the signal is handed off to a neighboring base station. Further, a plurality of signal strengths representative of signal handoffs may be recorded. In one embodiment, the set of collected signal strengths representing signal handoffs may be used to determine desired signal handoff threshold, which can be used to compare against the first indication to identify the predicted signal handoff. As an example, where historical data shows that signal strengths were at values of 2.1, 2.2 and 2.3 units of measure when signal handoffs occurred in the past, a predicted signal handoff may be identified when the first indication has a value of around 2.2 units of measure, for example.

In another embodiment, the signal difference may be combined with the first indication of signal strength, for example, to provide a third indication of signal strength. For example, the combination may indicate Cartesian coordinates that can be represented in a graph, where a first axis can comprise the signal difference, and the second axis can comprise the first indication of signal strength. In this example, the combination can indicate a point on the graph, and may be compared against points that indicate historical combinations of signal differences and first indications, comprising one or more representations of signal handoffs. For example, historical combinations that represent handoffs may be indicated by a point on the graph, and a line indicating a threshold for signal handoffs may be determined. In one embodiment the combination threshold can be compared to the third indication of signal strength to identify a predicted signal handoff.

In one embodiment, the signal handoff may be indicative of a location in which the signal handoff occurs. For example, when the mobile device moves from a current cell to a neighboring cell, a geographic location may be indicated at a point of signal handoff (e.g., crossing a cell boundary). It will be appreciated that the location of the signal handoff location may not be precisely repeatable every time the mobile device moves from the current cell to the neighboring cell, even when moving along a same path (e.g., due to equipment conditions, environmental conditions, etc.). For example, the location indicative of the signal handoff may comprise an area in which the signal handoff is likely to occur (e.g., based on empirical data) and/or an approximation of an area (e.g., an expanded area that the signal handoff will likely fall within).

In another embodiment, the signal handoff may be indicative of a time when the signal handoff occurs, or a combination of a time and place. For example, if a user of the mobile device is traveling by automobile along a road at a constant (e.g., or identified mean) speed, the signal handoff can occur at an identified time (e.g., or time/place) relative to the user. In one embodiment, if the signal handoff duration is constant, the signal handoff area will increase as the speed of the user of the mobile device increases. That is, for example, the distance the user travels during the signal handoff will be greater as the user's speed increases. In one embodiment, a location, direction, and speed of the mobile device may be determined in order to identify the predicted signal handoff, as discussed in more detail below.

At 112, having identified the predicted signal handoff, the exemplary method 100 ends.

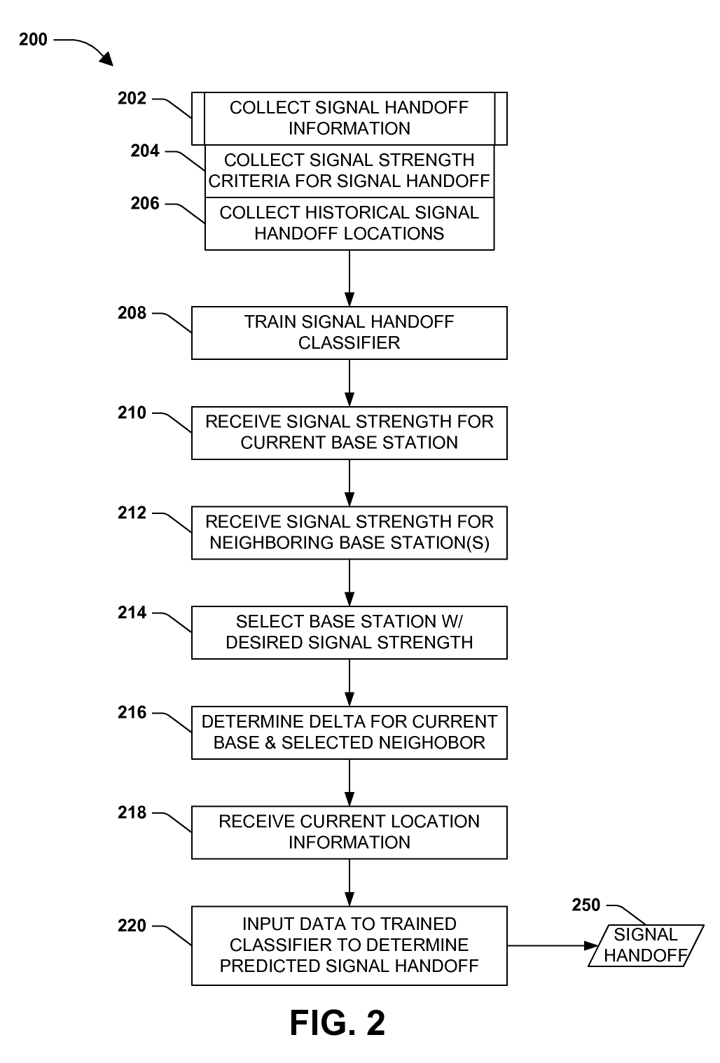

FIG. 2 is a flow diagram illustrating an example embodiment 200 where one or more portions of one or more techniques described herein may be implemented. At 202, signal handoff information can be collected. For example, handoff characteristics for a cellular network can be empirically determined, and/or provided by the cellular network provider. Signal handoff information can comprise signal strength criteria for one or more signal handoffs, at 204, (e.g., data collected when one or more signal handoffs actually occurred) and/or historical signal handoff locations, at 206 (e.g., respective locations of a mobile device when one or more signal handoffs occurred).

In one embodiment, measurements of signal strength during a signal handoff, and/or locations of the signal handoffs, may be gathered across one or more portions of a cellular network. In another embodiment, signal strength criteria used by the network provider to determine when to handoff the signal, and/or locations where signal handoffs occur may be provided by the network provider.

For example, empirical evidence may suggest, and/or the network provider may identify, a signal strength (e.g., or difference, or a combination of strength and difference) between the current base station and a neighboring base station that is used to trigger the signal handoff for a mobile device. As another example, empirical evidence may suggest, and/or the network provider may identify, a particular SNR difference (e.g., or range) between the current base station and a neighboring base station that is used to trigger the signal handoff for a mobile device.

At 208 in the example embodiment 200, a classifier can be trained to predict signal handoff. For example, the classifier can be trained over a set of signal strengths correlating to known signal handoffs, and a set of signal strengths correlating to instances when the signal was not handed off. In this way, for example, the classifier may be trained to predict a signal handoff given unclassified input (e.g., signal strength, signal strength difference, signal handoff location).

As an illustrative example, a linear kernel support vector machine (SVM) based classifier may be trained, such that it identifies a threshold using two features, such as SNR and SNR difference (between current base station and neighboring base station). In this example, the threshold identified by training the classifier can be used to distinguish between a predicted signal handoff and a predicted no signal handoff. In this way, in this example, when an unclassified SNR and SNR difference are input, the classifier can predict whether a signal handoff may occur.

At 210 in the example embodiment 200, an indication of signal strength is received for the current base station to which the mobile device is connected. As described above, the mobile device can comprise a radio that detects a pilot signal from the current base station. Further, the mobile device may save one or more signal strength readings locally, for example, and periodically send the saved pilot signal strength information to the network provider used by the mobile device to communicate. In one embodiment, the indication of signal strength for the current base station saved locally by the mobile device can be retrieved for use in detecting a signal handoff.

At 212, an indication of signal strength is received for one or more neighboring base stations. For example, as described above, a coverage cell corresponding the mobile device's current base station may be bounded by one or more neighboring cells, respectively corresponding to a neighboring base station (e.g., depending on location and coverage density). A signal for the respective one or more neighboring base stations may be detected by the mobile device, for example. In this example, the indication of signal strength for the respective one or more neighboring base stations can be saved locally for identifying a predicted signal handoff and/or reporting to the network provider.

At 214, a base station comprising a desired indication of signal strength can be selected, for example, for comparison with the current base station's indication of signal strength (e.g., a difference in signal strength). In one embodiment, the neighboring base station that comprises a strongest signal, of the one or more neighboring base stations, may be selected. That is, for example, the neighboring base station comprising the strongest signal for the mobile device may be more likely to be involved in a signal handoff (e.g., user is driving towards that base station), so its signal can be selected. As an illustrative example, as the mobile device moves closer to a boundary of the current cell, the signal strength of a neighboring cell can increase with respect to the mobile device, particularly for the neighboring cell immediately adjacent to the current cell edge. In this illustrative example, the signal handoff may occur when the mobile device is proximate to the current cell boundary, as determined by the signal strength of the current and neighboring base stations.

At 216, a delta (difference) of the indication of signal strength can be determined between the current base station and the selected neighboring base station (e.g., base station comprising the strongest signal). For example, the indication of signal strength (e.g., SNR) for the current base station can be subtracted from the indication of signal strength for the selected neighboring base station (e.g., or visa versa) to yield the delta.

At 218, a current location of the mobile device can be received. For example, one or more location services may be resident on the mobile device, that provide location coordinates for the mobile device (e.g., map grid location, longitude and latitude, etc.). As an illustrative example, the mobile device may be equipped with a global positioning system (GPS) that triangulates a physical position using satellites, and/or a signal location system that triangulates or estimates a position based on signal strength to one or more base stations.

At 220, signal handoff determination data can be input to the trained classifier. In one embodiment, the signal handoff determination data can comprise one or more indications or signal strength, and/or a location or the mobile device. Further, the one or more indications or signal strength can comprise signal strength, signal strength delta (between current and neighboring base station), SNR, and/or SNR delta, for example.

As an example, the SNR identified for the current base station, the SNR delta for the current base station and the strongest neighboring base station, and the mobile device location can be input to the classifier to determine a predicted signal handoff 250. In one embodiment, identifying the predicted signal handoff, such as by using the classifier, can comprise using an identified area where one or more signal handoffs may occur based on historical signal handoff data. In this embodiment, for example, the trained classifier may utilize the location of the mobile device to provide a prediction of signal handoff (e.g., by modifying a threshold), based on signal handoffs that historically occurred in the area of location.

As an illustrative example, historical data may indicate that signal handoffs often occur at the boundary of the current cell (e.g., or at a particular location due to interference), but rarely occur toward a center of the cell. In this example, this information may be used to adjust the threshold used by the classifier up or down, depending on the mobile device location. As an example, a higher threshold of signal handoff may be used when the mobile device is located near the cell center, and a lower threshold when near the cell boundary (e.g., or near an historical indication of interference).

Further, in one embodiment, the classifier may compare a combination of the input indications of signal strength against the desired threshold to determine the predicted signal handoff 250. As an illustrative example of how the classifier may predict the signal handoff, a value for the signal strength (e.g., RSCP or SNR) and a value for the signal strength difference (e.g., RSCP or SNR difference) can represent a Cartesian pair that indicates a point on a graph, having axes comprising the respective indications of signal strength. Further, the desired threshold (e.g., adjusted for location) may indicate a line (e.g., or region) on the graph, above which comprises a likelihood of signal handoff, and below comprises a likelihood that a signal handoff does not occur.

It will be appreciated that the classifier may not utilize the described graph to predict a signal handoff; the graph is being used merely to illustrate how the combination of inputs can provide the predicted signal handoff when applied to the trained classifier. Further, the signal handoff prediction is not limited a particular embodiment, and it is anticipated that those skilled in the art may devise alternate embodiments. For example, the predicted signal handoff may comprise a location prediction, identifying a location the signal handoff may occur. As another example, the predicted signal handoff may comprise a time prediction, identifying a time when the signal handoff may occur (e.g., based on a current location, travel speed and/or direction, etc.). As another example, the predicted signal handoff may comprise a likelihood, such as a probability (e.g., percentage value) that the signal handoff will occur within a specified time and/or location (e.g., if present speed and direction are maintained, a signal handoff is likely to occur (e.g., has an 85% probability of occurring) in x number of seconds at coordinates x longitude, y latitude).

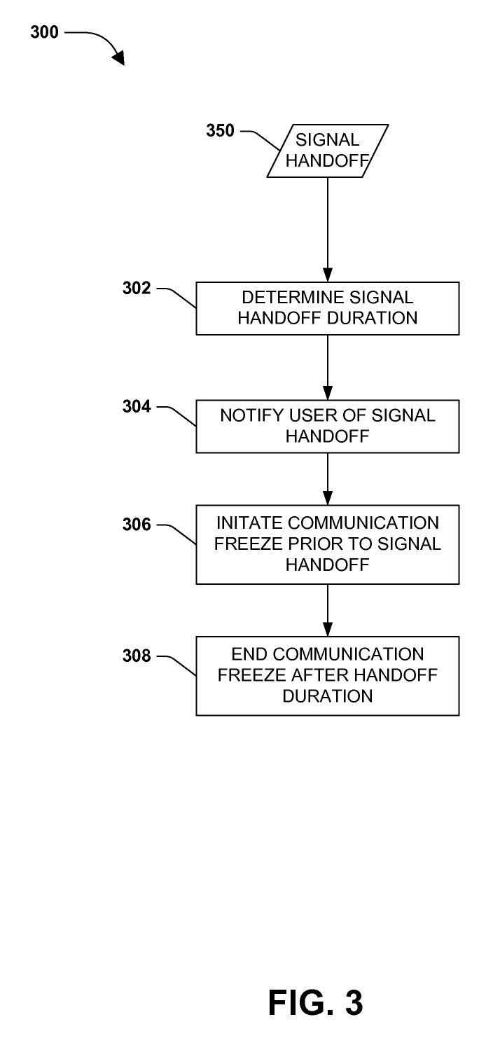

FIG. 3 is a flow diagram illustrating an example embodiment 300 of one or more portions of one or more techniques described herein. At 302, a predicted signal handoff 350 can be used to determine a signal handoff duration. A signal handoff duration can comprise a period of time, and/or distance, during which the signal is being handed off from a current base station to a neighboring base station (e.g., the neighboring base station comprising the strongest signal relative to other neighboring base stations). For example, if the user of the mobile device is traveling at a constant (e.g., or averaged) rate of speed the duration may comprise a time it takes for the user to travel across the boundary between neighboring cells, and/or a time it takes for the network to transfer the signal from the current base station to the neighboring base station. Further, in this example, the distance travelled during the signal handoff can vary based on the speed of travel; therefore, a signal handoff location may vary depending on the rate of travel of the mobile device.

In one embodiment, the signal handoff duration can be determined based at least in part upon historical signal handoff data associated with the network to which the mobile device connects for communication (e.g., voice, and/or data). For example, empirical duration data may be gathered that identifies a typical signal handoff duration for the network; and/or typical signal handoff duration information may be provided by the network provider.

In another embodiment, the signal handoff duration may comprise a desired threshold duration. For example, a default duration may be used as the threshold duration for the signal handoff, which may be devised from empirical data from a plurality of cellular networks. A default duration may be applied, for example, until an appropriate amount of signal handoff duration information is gathered for a particular network. In this example, a particular signal handoff duration can be determined from collecting the appropriate signal handoff duration information, and it may be replace the default duration for particular network, for example.

At 304 in the example embodiment 300, an indication of the predicted signal handoff 350 can be provided to a user of the mobile device, prior to the mobile device entering an area identified for the signal handoff. For example, upon detecting an impending predicted signal handoff, a notification may be activated on the mobile device (e.g., as a graphical user interface (GUI) element, and/or a sound alert). In this way, in this example, the user can be notified of the signal handoff prior to the signal handoff actually occurring.

In one embodiment, notifying the user of the predicted signal handoff may help the user decide on an action. For example, the user may be involved in (e.g., or about to begin) downloading/uploading data from/to a remote server. In this example, if the signal handoff occurs during the transfer of data, data may be lost due to data packet loss during the signal handoff.

When downloading data using a cellular network, data packets are typically buffered for the current base station. When the signal is handed to the neighboring base station, the buffered data packets can be lost, as the transmission at the newly connected neighboring base station begins where the last data packet sent to the former current base station left off. That is, for example, the last data packet sent to the former current base station may be one of several cached in a buffer that have not been received by the mobile device. Therefore, in this example, the buffered data packets may never reach the mobile device if the signal is handed off during transmission, and may need to be retransmitted, resulting in a delay spike.

As another example, the user may be about to begin a telephone conversation using the mobile device, and upon being notified of the impending predicted signal handoff, postpone the telephone call until after the predicted signal handoff. In one embodiment, information for an area identified as comprising a predicted signal handoff can be integrated with a mapping service used to indicate the identified area on a map. In this embodiment, for example, utilizing the mapping service, a user may be able to identify an area that comprises one or more predicted signal handoffs, and plan accordingly (e.g., when to receive/send data or make phone calls, and/or travel route planning). For example, a large city may comprise a plurality of base stations serving a dense cell network. In this example, areas of the city may comprise more signal handoffs than others, due to physical or electrical interference (e.g., buildings, electro-magnetic fields). These indications may be identified by the user, and used to plan a route of travel, for example.

At 306 in the example embodiment 300, a data communication freeze can be initiated between the mobile device and a network with which the mobile device is communicating, based at least in part upon the predicted signal handoff 350. For example, the predicted signal handoff 350 can be used by a mobile application on the mobile device to choose not to communicate during the signal handoff in order to avoid packet losses and unnecessary retransmissions. In this embodiment, the data communication freeze can be initiated by a mobile application or the mobile device, for example, thereby pausing the data communication at a known place in the transmission.

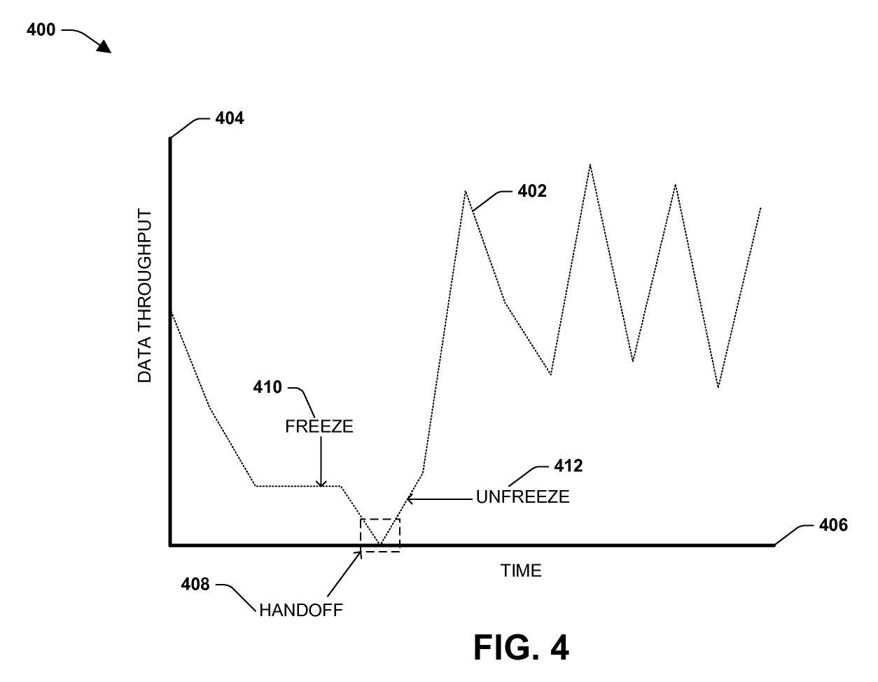

At 308, the data communication freeze between the mobile device and the network can be ended after a signal handoff has completed. In one embodiment, the data communication freeze between the mobile device and the network can be ended after the signal handoff duration. As an illustrative example, FIG. 4 is a graph diagram illustrating an example embodiment 400 of a signal handoff. In the example embodiment 400, the graph line 402 represents a data throughput level 404 over a period of time 406. A signal handoff 408 is represented at a time 406 when the data throughput 404 approaches zero, then returns to nominal operation levels.

In this example, the predicted signal handoff may identify an approximate time that corresponds to the actual signal handoff 408. In this way, for example, the signal handoff duration may begin at a time of the data communication freeze 410, and end at a time of the unfreezing 412 of the data communication. In one embodiment, the data communication freeze 410 should begin prior to the predicted signal handoff (e.g., and actual signal handoff 408), and end after the signal handoff 408 has completed. As described above, the signal handoff duration may be determined by historical signal handoff information, and or may comprise a desired threshold (e.g., default duration).

A system may be devised that can be used to identify potential signal handoffs (e.g., comprising locations and/or times) for a mobile device. A prediction may be made based on an indication of signal strength between the mobile device and a current base station connected to the mobile device, and one or more neighboring base stations. The indication(s) of signal strength, such as signal strength, signal-to-noise ratio (SNR), and/or differences between indications, can help identify where and/or when a signal handoff from the current base station to a neighboring base station may occur.

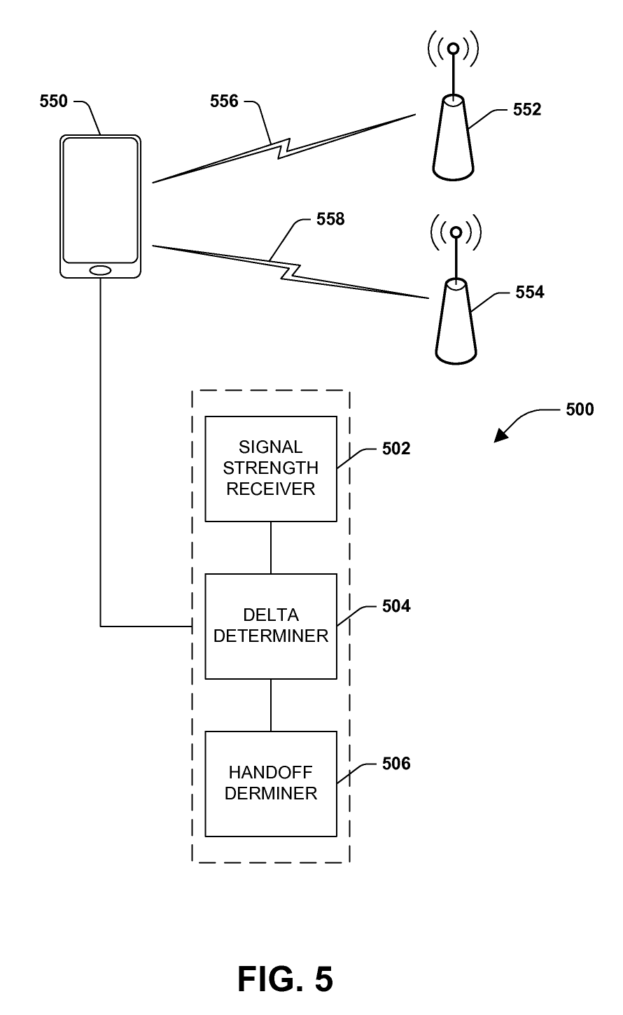

FIG. 5 is a component diagram illustrating an exemplary system 500 for predicting when a signal handoff may occur between base stations for a mobile device. A signal strength receiving component 502 is configured to receive a first indication of signal strength between the mobile device 550 and a current base station 552. Further, the signal strength receiving component 502 is configured to receive a second indication of signal strength between the mobile device 550 and a neighboring base station 554.

For example, the mobile device 550 may receive a first signal 556 from the current base station 552, which can be used to connect to a network providing communication (e.g., voice and/or data) for the mobile device. The mobile device 550 may also receive a second signal 558 from the neighboring base station 554, for example, to which the mobile device 550 is not presently connected for network communication. In one embodiment, the mobile device may identify the first and second indications of signal strength from the received first 556 and second 558 signals.

A delta determination component 504 is operably coupled with the signal strength receiving component 502, and is configured to determine a signal difference between the first indication and the second indication. For example, as mobile device 550 moves farther from the current base station 552 and closer to the neighboring base station 554, the signal difference can change. As an illustrative example, the first signal 556 may become weaker and the second signal 558 stronger as the mobile device 550 moves toward a boundary between the current cell and neighboring cell. In this example, the difference may approach zero when traveling toward the boundary, and increase after crossing the boundary traveling toward the neighboring base station. In one embodiment, the signal strength indication difference may be an effective indicator (e.g., among others) of a potential signal handoff.

In the exemplary system 500, a handoff determination component 506 is operably coupled with the delta determination component, and configured to identify a predicted signal handoff based at least in part on the signal difference. For example, the handoff determination component 506 can comprise a sort of classifier that uses the signal difference to identify when or where a signal handoff may occur. In one embodiment, the handoff determination component 506 can receive indication differences from the delta determination component 504, and merely provide a predicted signal handoff when indicated by a corresponding indication difference (e.g., the difference triggers a signal handoff prediction in the classifier).

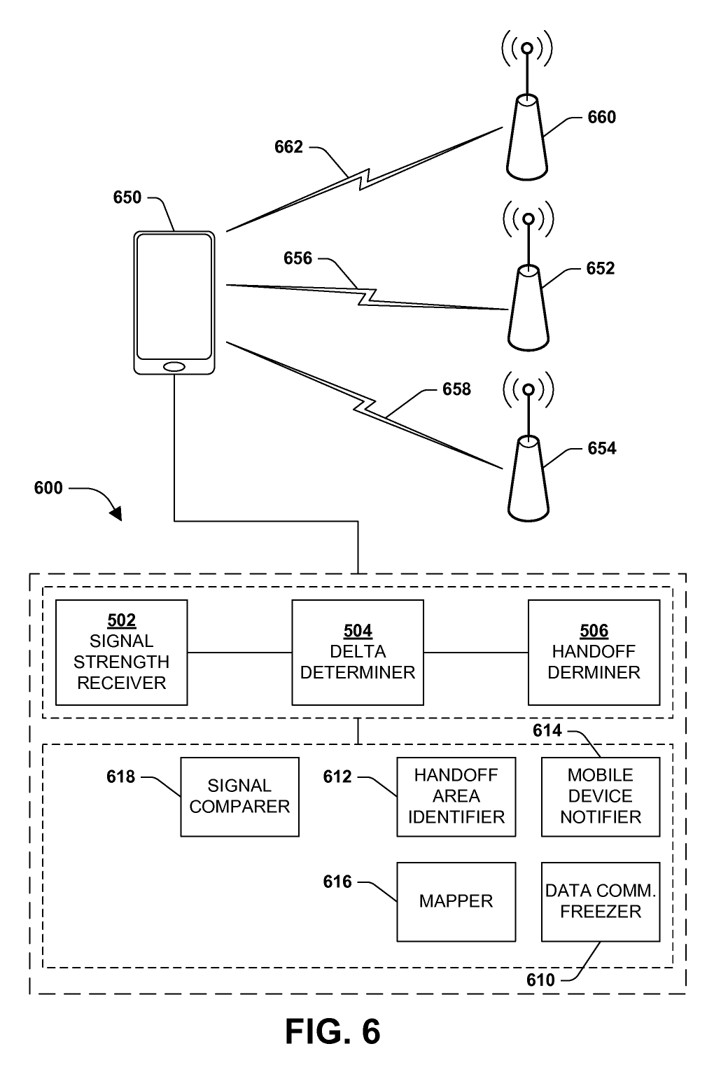

FIG. 6 is a component diagram illustrating an example embodiment 600 where one or more systems described herein may be implemented. In this example 600, an extension of FIG. 5 is provided and thus description of elements, components, etc. described with respect to FIG. 5 may not be repeated for simplicity. In this example embodiment 600, a data communication freeze component 610 can be configured to initiate a data communication freeze between the mobile device 650 and a network with which the mobile device 650 is communicating prior to a predicted signal handoff. Further, the data communication freeze component 610 can be configured to end the data communication freeze between the mobile device 650 and the network after a signal handoff has completed; and/or end the data communication freeze between the mobile device 650 and the network after a signal handoff duration (e.g., period of time lapses).

A handoff area identification component 612 can be configured to identify an area comprising one or more signal handoffs for the mobile device 650 based at least in part upon historical signal handoff data. In one embodiment, the handoff determination component 506 can be configured to identify the predicted signal handoff based at least in part on one or more areas identified by the handoff area identification component 612. For example, the handoff area identification component 612 can provide information that identifies previous locations of signal handoffs to the handoff determination component 506. In this example, the location information may help refine the predicted signal handoff identified by the handoff determination component 506 (e.g., adjusting a threshold for classifying the signal handoff), and/or may also help identify an area where the predicted signal handoff is likely to occur.

In the example embodiment 600, a mobile device notification component 614 can be configured to provide an indication of the predicted signal handoff to a user of the mobile device 650 prior to the predicted signal handoff. For example, the mobile device notification component 614 may provide a notification to the mobile device 650, which can display a graphical user interface (GUI) element (e.g., an icon, badge or other indicator) on a display of the mobile device, and/or an audible notification. Further, as an example, the notification provided by the mobile device notification component 614 may be provided to an application resident on the mobile device, which uses the connection to the network for data transmission (e.g., upload and/or download). In this way, in this example, the user and/or the application can be made aware of the predicted signal handoff so that appropriate actions may be undertaken.

A mapping component 616 can be configured to indicate one or more predicted signal handoffs on a map based at least in part upon historical signal handoff data integrated with a mapping service. For example, the predicted signal handoffs identified by the handoff determination component 506 may be utilized by the mapping component 616 for integration into a map. In this way, for example, the user of the mobile device may be able to identify potential signal handoff locations using the map service, which can be accessed with the mobile device. Further, as an example, predicted signal handoffs may be integrated from other mobile devices utilizing the mapping service; thereby providing information for areas that the user may not have previously traveled.

A signal comparison component 618 can be configured to compare respective indications of signal strength from a plurality of neighboring base stations 654, 660 to identify a neighboring base station comprising a desired indication of signal strength. For example, the mobile device 650 may be receiving a signal 656, 658, 662 from a current base station 652 to which the mobile device 650 is connected, a first neighboring base station 654, and a second neighboring base station 660. In this embodiment, for example, the signal comparison component 618 can identify which signal 658, 662 of the two neighboring base stations 654, 660 comprises a strongest indication of signal strength.

In this way, for example, the strongest indication of signal strength may be used by the delta determination component 504 when it determines the difference. As an example, the neighboring base station 654, 660 comprising the strongest signal of the respective neighboring base stations 654, 660 is most likely to be the one to which the signal will be handed off to when the signal handoff occurs. As an illustrative example, if the mobile device is moving toward the first neighboring base station 654 and away from the second neighboring base station 660, the signal comparison component 618 may identify that the first neighboring base station signal 658 comprises a strongest indication of signal strength, which may be desired for use in the difference determination over a weaker signal from the second neighboring base station 660.

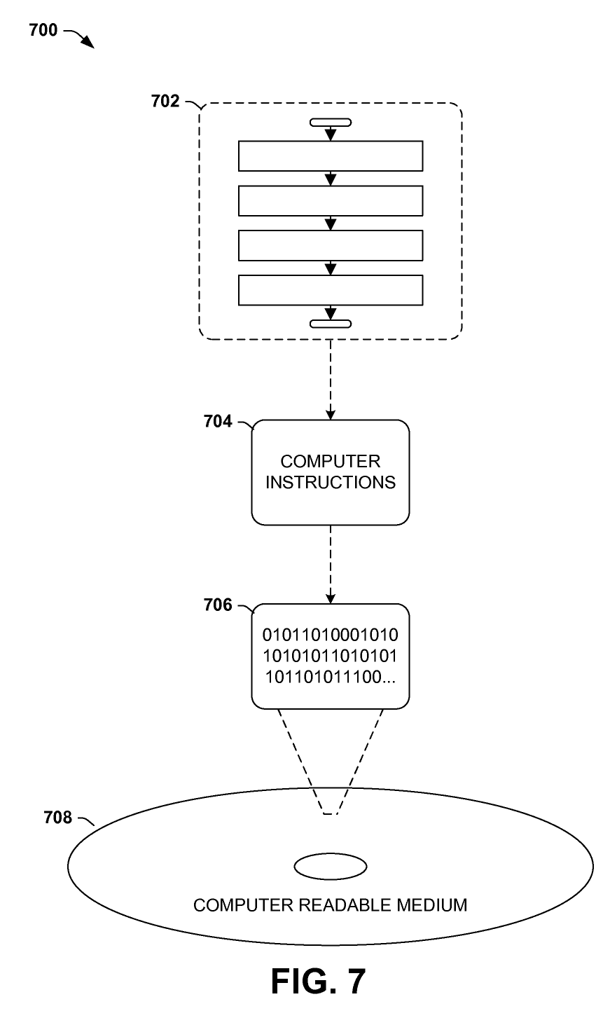

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

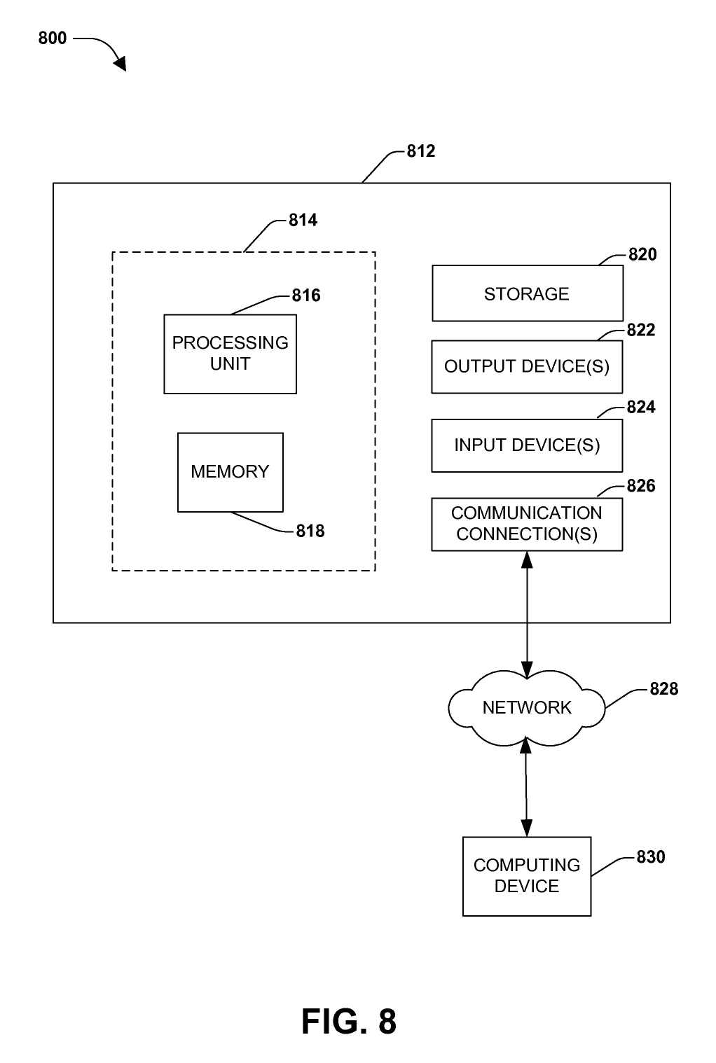

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1-20. (canceled)

21. A tangible computer readable storage device comprising computer executable instructions that when executed via a processing unit perform a method for predicting a signal handoff between base stations for a mobile device, comprising:
receiving a first indication of signal strength between the mobile device and a current base station;
receiving a second indication of signal strength between the mobile device and a neighboring base station;
determining a signal difference between the first indication and the second indication; and
predicting a signal handoff between the current base station and the neighboring base station based at least in part upon the signal difference between the first indication and the second indication, the signal handoff predicted to occur when the difference between the first indication and the second indication meets a desired threshold; and
initiating a data communication freeze associated with the mobile device, the data communication freeze occurring during a signal handoff duration, the signal handoff duration indicative of a time range during which the predicted signal handoff may occur.

22. The computer readable storage device of claim 21, initiating the data communication freeze associated with the mobile device comprising:
initiating the data communication freeze between the mobile device and a network with which the mobile device is communicating via at least one of the current base station or the neighboring base station.

23. The computer readable storage device of claim 21, predicting the signal handoff comprising:
predicting the signal handoff duration based at least in part upon historical signal handoff data such that the predicted signal handoff duration may be of a first length when the mobile device is associated with a first network and a second length when the mobile device is associated with a second network

24. The computer readable storage device of claim 21, predicting the signal handoff between the current base station and the neighboring base station comprising:
identifying one or more areas where signal handoffs historically occur using historical signal handoff data; and
determining whether the mobile device is comprised within at least some of the identified one or more areas where signals handoffs historically occur.

25. The computer readable storage device of claim 24, comprising providing for presentation to a user of the mobile device an indication of at least some of the identified one or more areas where signal handoffs historically occur.

26. The computer readable storage device of claim 24, comprising integrating information related to at least some of the identified one or more areas where signal handoffs historically occur with a mapping service.

27. The computer readable storage device of claim 21, comprising providing for presentation to a user of the mobile device an indication of the predicted signal handoff.

28. The computer readable storage device of claim 21, comprising ending the data communication freeze prior to a specified end time of the signal handoff duration when the predicted signal handoff is completed before the specified end time.

29. The computer readable storage device of claim 28, comprising ending the data communication freeze at the specified end time of the signal handoff duration when the predicted signal handoff has not been completed before the specified end time.

30. The computer readable storage device of claim 21, at least one of:
the first indication of signal strength comprising an indication of a signal-to-noise ratio for a signal between the mobile device and the current base station, or
the second indication of signal strength comprising an indication of a signal-to-noise ratio for a signal between the mobile device and the neighboring base station.

31. The computer readable storage device of claim 21, predicting the signal handoff between the current base station and the neighboring base station comprising:
comparing the signal difference to a set of historical indications of signal differences.

32. A method for predicting a signal handoff between base stations for a mobile device, comprising:
receiving a first indication of signal strength between the mobile device and a current base station;
receiving a second indication of signal strength between the mobile device and a neighboring base station;
determining a signal difference between the first indication and the second indication; and
predicting a signal handoff between the current base station and the neighboring base station based at least in part upon the signal difference between the first indication and the second indication, the signal handoff predicted to occur when the difference between the first indication and the second indication meets a desired threshold, at least some of the method implemented at least in part via a processing unit.

33. The method of claim 32, predicting the signal handoff between the current base station and the neighboring base station comprising:
predicting a signal handoff duration indicative of a time range during which the predicted signal handoff may occur.

34. The method of claim 33, comprising initiating a data communication freeze between the mobile device and a network with which the mobile device is communicating, the data communication freeze occurring during the signal handoff duration.

35. The method of claim 34, comprising ending the data communication freeze prior to a specified end time of the signal handoff duration when the predicted signal handoff is completed before the specified end time.

36. The method of claim 35, comprising ending the data communication freeze at the specified end time of the signal handoff duration when the predicted signal handoff has not been completed before the specified end time.

37. The method of claim 33, predicting the signal handoff duration comprising:
predicting the signal handoff duration based at least in part upon historical signal handoff data such that the predicted signal handoff duration may be of a first length when the mobile device is associated with a first network and a second length when the mobile device is associated with a second network.

38. The method of claim 32, at least one of:
the first indication of signal strength comprising an indication of a signal-to-noise ratio for a signal between the mobile device and the current base station, or
the second indication of signal strength comprising an indication of a signal-to-noise ratio for a signal between the mobile device and the neighboring base station.

39. The method of claim 32, comprising determining the second indication of signal strength based at least in part upon selecting a strongest signal from a set of one or more neighboring base stations.

40. The method of claim 32, predicting the signal handoff between the current base station and the neighboring base station comprising:
comparing the signal difference to a set of historical indications of signal differences.

41. The method of claim 32, predicting the signal handoff between the current base station and the neighboring base station comprising:
inputting the signal difference into a classifier trained to predict whether a signal handoff is to occur.

42. The method of claim 32, predicting the signal handoff between the current base station and the neighboring base station comprising:
identifying one or more areas where signal handoffs historically occur using historical signal handoff data; and
determining whether the mobile device is comprised within at least some of the identified one or more areas where signals handoffs historically occur.

43. The method of claim 42, comprising providing for presentation to a user of the mobile device an indication of at least some of the identified one or more areas where signal handoffs historically occur.

44. The method of claim 42, comprising integrating information related to at least some of the identified one or more areas where signal handoffs historically occur with a mapping service.

45. The method of claim 32, comprising providing for presentation to a user of the mobile device an indication of the predicted signal handoff.

46. A system for predicting a signal handoff between base stations for a mobile device, comprising:
one or more processing units; and
memory comprising instructions that when executed by at least some of the one or more processing units implement at least some of the following:
a signal strength receiving component configured to:
receive a first indication of signal strength between the mobile device and a current base station; and
receive a second indication of signal strength between the mobile device and a neighboring base station;
a delta determination component, operably coupled with the signal strength receiving component, configured to determine a signal difference between the first indication and the second indication; and
a handoff determination component, operably coupled with the delta determination component, configured to predict a signal handoff between the current base station and the neighboring base station based at least in part upon the signal difference between the first indication and the second indication, the signal handoff predicted to occur when the difference between the first indication and the second indication meets a desired threshold.

47. The system of claim 46, comprising a data communication freeze component configured to at least one of:
initiate a data communication freeze associated with the mobile device based upon the predicted signal handoff;
end the data communication freeze after the predicted signal handoff is completed; or
end the data communication freeze after a signal handoff duration, the signal handoff duration indicative of a time range during which the predicted signal handoff may occur, has lapsed.

48. The system of claim 46, comprising a handoff area identification component configured to identify one or more areas where signal handoffs historically occur.

49. The system of claim 48, the handoff determination component configured to utilize information related to the identified one or more areas where signal handoffs historically occur to predict the signal handoff.

50. The system of claim 46, comprising a mobile device notification component configured to provide an indication of the predicted signal handoff prior to the signal handoff occurring.
